(19) United States
(12) Patent Application Publication
(10) Pub. No.: US 2025/0275568 A1
(43) Pub. Date: Sep. 4, 2025

(54) ROASTING MODULE AND PROCESSING LINE FOR NATURAL PRODUCTS, AS WELL AS THEIR USES

(71) Applicant: COMPANYONE AG, Allschwil (CH)

(72) Inventors: Cameon IVARSSON, Zug (CH); Dieter KÜNDIG, Zug (CH)

(21) Appl. No.: 18/719,605

(22) PCT Filed: Dec. 13, 2022
(86) PCT No.: PCT/EP2022/085601

§ 371 Date: Jun. 13, 2024

(30) Foreign Application Priority Data
Dec. 14, 2021 (CH) 070711/2021

(51) Int. Cl. A23N 12/12

(52) U.S. Cl. CPC A23N 12/125

(57) ABSTRACT

The present invention concerns a roasting module (10) for roasting natural products, in particular beans, grains, seeds or nuts, comprising a tray (11), in particular a cubic tray, for containing the products to be roasted, wherein the tray comprises a bottom in the form of an inverted truncated pyramid (15), a grid covering the larger base (15a) of the inverted pyramid, wherein the mesh of the grid is sufficiently small to retain the products to be roasted when placed on the grid, the tray further comprising an opening (12) positioned opposite the inverted pyramid (15), the opening (12) being configured to introduce the products to be roasted into the tray, the tray further comprising on the smaller base (15b) of the inverted pyramid an air inlet (16), the roasting module (10) comprising first means for supplying hot air into the tray through the inlet (16), wherein the inlet (16) and the first means for supplying hot air are adapted to supply a flow of hot air with a rate of at least 4′000 m³/hour per 1 m of height of products to be roasted and per 1 m² of surface of the larger base (15a) of the inverted pyramid and in that the first means for supplying hot air are adapted to supply air at a temperature in the range of 105° C. to 250° C., preferably at a temperature range between 115° C. and 200° C., advantageously between 125° C. and 170° C., in particular between 135° C. and 150° C. The invention relates also to a processing line (100) for natural products comprising a roasting module (10) according to the present invention, as well as to the use of such roasting module (10) or such processing line (100) for roasting of natural products, especially of beans, grains, seeds or nuts.

### PRIOR RELATED APPLICATIONS

The present application is a National Entry of PCT Application No. PCT/EP2022/085601, filed on Dec. 13, 2022, which claims priority under the Paris Convention to Finnish Application No. CH 070711/2021, filed on Dec. 14, 2021. The entire contents of such prior applications are incorporated by reference herein.

### TECHNICAL FIELD

The present invention relates to the field of roasting modules for roasting natural products, in particular beans, grains, seeds and nuts, more preferably of beans, seeds and nuts. The present invention also concerns a processing line for processing, in particular roasting, natural products like beans, grains, seeds and nuts comprising a roasting module according to the present invention. Furthermore, the present invention is directed to the use of such roasting module or such processing line for roasting of natural products, especially of beans, grains, seeds and nuts.

### BACKGROUND OF THE INVENTION

Roasting of natural products is a complex process that must lead to a homogeneous torrefaction of all products of a certain batch. In order to achieve a homogenous torrefaction, roasting processes and devices known from the prior art require displacing the product in an airflow or across a hot surface or exposing it to radiant heat, in order to achieve a uniform heating of all particles and the entire surface of the product. Displacement of the product requires mechanical devices which tumble, vibrate, shake, rotate, or stir the load in order to keep the product moving.

Most known industrial roasters work in a continuous way and the product particles are moved on a belt, on a vibratory support or by an air flow through the different steps of the roasting process. The roasting is achieved by exposing the product particles to a flow of hot air at a settable temperature, thus allowing to achieve different roasting degrees, from light to dark roasting.

Some roasters, mainly for smaller throughputs per hour, are designed as a batch system. They have in common that the product must be moved during the process to achieve a homogenous roasting effect. The movement can be achieved by tumbling the product in a drum or by moving arms or paddles which are stirring the product during the process.

Displacing the product itself during the roasting process results in damage to the product such as breakage and scuffing generating dust, waste, and broken particles. In devices where the product is displaced scuffing and breakage generate dust and broken particles that require cleaning and significant down time for that. Furthermore, mechanical means for displacing product are accompanied by wear and tear of moving parts necessitating significant maintenance and down time.

Finally, the volume of product exposed to the heat needs to be controlled in roasting processes in order to avoid over or under roasting. In continuous roasters, i.e. roaster where the product itself is displaced, start-up and shut down phases of the roasting line can be challenging because of build-up and dwindling of the product layer at those times.

A goal of the present invention is to propose a novel roasting module and a novel processing line that allow for roasting products without needing mechanical means to move the product itself through a roasting process. It is therefore also a goal of the present invention to reduce damage and waste of the product and to reduced cleaning time due to dust and broken pieces.

### SUMMARY OF THE INVENTION

Thus, the object of the present invention is to propose a novel roasting module and a novel processing line with which the above-described drawbacks of the known systems are completely overcome or at least greatly diminished.

According to the present invention, these objectives are achieved in particular through the elements of the two independent claims. Further advantageous embodiments follow moreover from the dependent claims and the description.

In particular, the objects of the present invention are achieved by a roasting module for roasting natural products, in particular beans, seeds or nuts, comprising a tray, in particular a cubic tray, for containing the products to be roasted, wherein the tray comprises a bottom in the form of an inverted truncated pyramid, a grid covering the larger base of the inverted pyramid, wherein the mesh of the grid is sufficiently small to retain the products to be roasted when placed on the grid, the tray further comprising an opening positioned opposite the inverted pyramid, the opening being configured to introduce the products to be roasted into the tray, the tray further comprising on the smaller base of the inverted pyramid an air inlet, the roasting module comprising first means for supplying hot air into the tray through the inlet, wherein the inlet and the first means for supplying hot air are adapted to supply a flow of hot air with a rate of at least 4′000 m³/hour per 1 m of height of products to be roasted and per 1 m² of surface of the larger base of the inverted pyramid and wherein the first means for supplying hot air are adapted to supply air at a temperature in the range of 105° C. to 250° C., preferably at a temperature range between 115° C. and 200° C., advantageously between 125° C. and 170° C., in particular between 135° C. and 150° C.

The inventors have found out that it is necessary to obtain homogenous roasting of the products in the tray, to supply hot air with a temperature in the above-mentioned temperature range and with a flow rate of at least 4′000 m³/hour per 1 m height of products in the tray and per 1 m² of surface of the larger base of the inverted pyramid. Thanks to such a roasting module it is possible to homogenously roast a large quantity of natural products without having to move the products themselves through a flow of hot air or through another source of heat. This is advantageous since this avoids damages to the product and the production of dust and broken pieces. Furthermore, since the roasting process is performed “batchwise” (a batch being the quantity of products in the tray), the traceability of the products is improved. It is important to note that although the tray is part of the roasting module, the tray is configured so that it can be separated from the module to transport the product to another module, such as a cooling module.

Preferred natural products to be roasted are tree nuts, ground nuts, grains and edible seeds, as well as beans.

“Tree nuts” encompass any kind of tree nuts such as e.g. almonds, hazelnuts, chestnuts, walnuts, pecans, cashews, macademias, pistachios, pine kernels, and Brazil nuts. Preferred tree nuts are almonds, hazelnuts, pecans, cashews, macadamias and pistachios.

“Ground nuts” encompass any kind of ground nuts such as e.g. peanuts and tigernuts. Preferred ground nuts are peanuts.

“Grains and edible seeds” encompass any kind of grains and edible seeds such as e.g. quinoa, amaranth, maize, rice, wheat, buckwheat, oat, malt, pumpkin seeds, chia seeds, sesame seeds, poppy seeds and sunflower seeds. Preferred grains and edible seeds encompass sunflower seeds, sesame seeds, oat, malt, and pumpkin seeds.

“Beans” encompass any kind of beans such as e.g. soybeans, kidney beans, chickpeas, common peas, fava beans, lima beans, lupins, mung beans, pigeon beans and runner beans.

In an embodiment of the present invention the roasting module is one for roasting cocoa beans. If cocoa beans are roasted, preferably roasting temperatures in the range of 105 to 135° C., more preferably in the range of 112 to 130° C., are applied.

In an embodiment of the present invention the roasting module is one for roasting coffee beans. If coffee beans are roasted, higher roasting temperatures, i.e. temperatures in the range of 200 to 250° C., are advantageously applied.

In a further embodiment of the present invention the inlet and the first means for supplying hot air are adapted, depending on the physical characteristics of the natural product to be roasted such as e.g. bulk density and geometric shape, to supply a flow of hot air with a rate in the range of from 4′000 m³/hour to 9′000 m³/hour per 1 m of height of products to be roasted and per 1 m² of surface of the larger base of the inverted pyramid.

In a first preferred embodiment of the present invention, the roasting module comprises a cover for covering the opening, wherein the cover comprises an outlet to direct hot air outside the tray. This is favourable since a cover allows for reducing the heat loss and therefore the roasting time. Moreover, the cover allows for increasing the reproducibility in the roasting process by isolating the content of the tray from the environment.

In a second preferred embodiment of the present invention, the cover of the tray comprises a seal, preferably an inflatable seal, to allow for a tight connection of the cover and the tray to force the airflow through the product. “Tight” in this context means that the loss of air is below 5 Vol. %, preferably below 2 Vol. %, preferably below 1 Vol. %. With such a tight connection between cover and tray it is also possible to change the direction of the airflow at least once during the roasting process, either from top to bottom or vice versa. This is advantageous for a homogenous roasting of the complete load of the tray, and thus further increases the homogenity of the product.

Therefore, the roasting module advantageously comprises means for inverting the flow direction of the hot air.

In another preferred embodiment of the present invention, the roasting module comprises means for adjusting the temperature of the hot air to be supplied into the tray. This allows for executing different roasting recipes according to for instance the type and/or quantity of products in the tray.

In yet another preferred embodiment of the present invention, the roasting module comprises a temperature sensor for measuring the temperature inside the tray. This allows for a control of the temperature of the roasting process.

In a further preferred embodiment of the present invention, the roasting module comprises a humidity sensor for measuring the humidity level inside the tray. This allows for a control of the humidity during the roasting process.

In yet a further preferred embodiment of the present invention, the means for adjusting the temperature of hot air is configured to receive data from the temperature sensor and/or the humidity sensor and to adjust the temperature of hot air to be supplied into the tray in function of the data received.

In a further preferred embodiment of the present invention, the first means for supplying hot air into the tray comprises a delivery fan with variable speed to adjust the airflow depending on the density of the product in the tray.

In a further preferred embodiment of the present invention, the roasting module comprises a fan with variable speed to adjust the airflow exiting the tray through the outlet.

In another preferred embodiment of the present invention, the inlet is connected to an air filter, especially a HEPA filter.

In a further preferred embodiment of the present invention, the inlet comprises a seal, preferably an inflatable seal, to allow for a tight connection of the inlet and the tray to force the airflow through the product. “Tight” in this context means that the loss of air is below 5 Vol. %, preferably below 2 Vol. %, preferably below 1 Vol. %. This tight connection between the inlet and the tray allows to change the direction of the airflow at least once during the roasting process, either from top to bottom or vice versa. This is advantageous for a homogenous roasting of the complete load of the tray, and thus further increases the homogenity of the product.

In an alternative preferred embodiment, especially of larger processing lines comprising more than one roasting module, the duct of each roasting module comprises a seal, preferably a seal which can be inflated once the tray is positioned thereon, to make the connection between each duct and the one or more trays airtight. “Airtight” in this context means that the loss of air is below 5 Vol. %, preferably below 2 Vol. %, preferably below 1 Vol. %. This allows also for a change of the direction of the airflow at least once during the roasting process, either from top to bottom or vice versa. After the airflow has passed from the air inlet on the bottom of the tray through the tray, the air is then evacuated through the outlet of the cover of the tray. Alternatively the air may be pushed through the outlet of the cover of the tray into the tray and evacuated through the inlet at the bottom of the tray.

In a further embodiment of the present invention the inlet as well as the duct of the roasting module both comprise a seal, preferably an inflatable seal.

In a further preferred embodiment of the present invention, the inlet as well as the duct of each roasting module of a processing line both comprise a seal, preferably an inflatable seal. In an even more preferred embodiment of the present invention, the cover of the tray of each roasting module of the processing line also comprises a seal.

In a second aspect, the goals of the present invention are achieved by a processing line for natural products, especially seeds, grains, beans and nuts, more preferably seeds, beans and nuts, wherein it comprises a pre-heater module for heating the natural products to a temperature of 40 to 120° C., advantageously of 60° C. to 90° C., in particular of 70° C. to 80° C., a cooling module for cooling the products to ambient temperature and between the pre-heater module and the cooling module a roasting module according to the present invention, wherein the processing line comprises means for displacing the tray for containing the products from the pre-heater module to the roasting module and from the roasting module to the cooling module. Such means may e.g. be an electric chain conveyor with frequency inverter.

If the pre-heater module and/or the cooling module are also equipped with seals and means for inverting the flow direction of the hot air, the direction of the flow of the hot air in these modules may also be inverted.

In an embodiment of the processing line of the present invention the flow in the pre-heater module and the cooling module, respectively, is from bottom to top.

In a special embodiment of the present invention the air in the pre-heater module is sucked off at the top instead of pushed through from the bottom to the top.

In a preferred embodiment of the present invention at least one of these modules in such processing line is made from stainless steel. In an especially preferred embodiment all the modules in such processing line are made from stainless steel.

A processing line according to the present invention allows for a complete processing of natural products comprising the steps of pre-heating, roasting and cooling without the need for transporting the products to be processed themselves. This permits to avoid damaging the products and the production of dust and broken pieces.

In a first preferred embodiment of this aspect of the present invention, the processing line comprises between the pre-heater module and the roasting module, a pasteurization module for pasteurizing the products. Thanks to the pasteurization module, the products can be, after having been pasteurized, roasted.

In a second preferred embodiment of the processing line the pasteurization module and the one or more roasting modules are located in a clean room area.

In another preferred embodiment of this aspect of the present invention, the pre-heater module comprises second means for supplying hot air into the tray, wherein the second means are configured to supply air with a temperature from 40° C. to 120° C., advantageously from 60° C. to 90° C., in particular from 70° to 80° C., through the inlet of the tray. This allows for a homogenous pre-heating of the products.

In another preferred embodiment of this aspect of the present invention, the cooling module comprises means for supplying cooled air into the tray, wherein the means for supplying cooled air are configured to supply air with a temperature from 15° C. to 35° C. through the inlet of the tray. This allows for a homogenous cooling of the products.

In yet another preferred embodiment of this aspect of the present invention, the processing line comprises a controller for adjusting the temperature of the air supplied into the tray by the pre-heater module, the roasting module, and the cooling module. This allows for a complete control of the temperature conditions in the different modules.

In a further preferred embodiment of this aspect of the present invention, the controller is configured to control the means for displacing the tray between the modules. This allows for controlling the time that the products stay in each module.

In yet a further preferred embodiment of this aspect of the present invention, each of the pre-heater module, the cooling module and the roasting module comprises a separated cover for covering the opening of the tray, wherein the covers exhibit an outlet for directing air outside the tray. This allows for minimising the processing time in each module.

At present it is possible to roast up to 6 tons of natural product per hour in such a processing line, whereby the humidity of the starting natural product is approximately in the range of 4 to 10 weight-% of its total weight.

The processing line comprising a pre-heater module, a pasteurization module, a roasting module and a cooling module (total length; 9.8 m; total width: 4.8 m), of the present invention is also sustainable since the maximum footprint for a throughput of 1 ton per hour is 47 m².

To further increase the sustainability of the roasting module and also the processing line the used air is at least partially recirculated. In one embodiment thereof advantageously the air is dried after leaving the roasting module and before bringing it at least partially into the pre-heater module.

The present invention is also directed to the use of a roasting module with the preferences as disclosed above, as well as to the use of a processing line with the preferences as disclosed above for roasting of natural products, in particular for roasting of beans, grains, seeds or nuts, more preferably for roasting of beans, seeds, tree nuts or ground nuts with the preferences as given above.

### BRIEF DESCRIPTION OF THE DRAWINGS

FIG. 1 is a perspective view of a tray of a roasting module according to an embodiment of the present invention;

FIG. 2 is a sectional view of a tray of a roasting module according to an embodiment of the present invention;

FIG. 3 is a perspective view of a roasting module according to an embodiment of the present invention; and

FIG. 4 is a side view of a processing line according to an embodiment of the present invention.

### DETAILED DESCRIPTION OF A PREFERRED EMBODIMENT

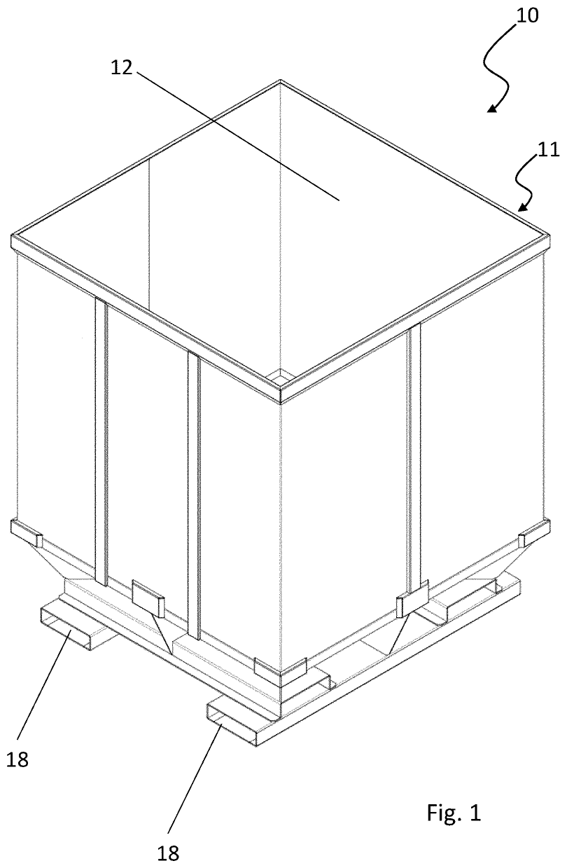

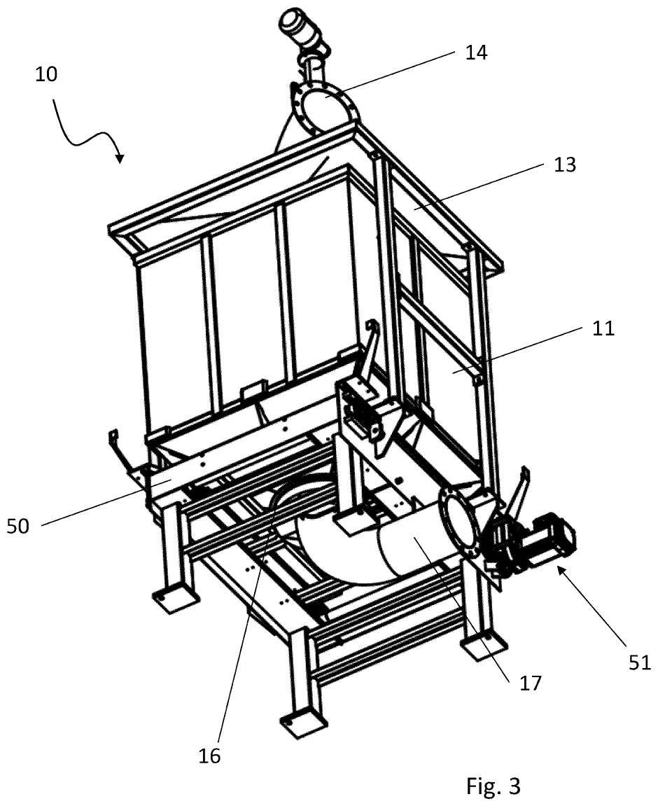

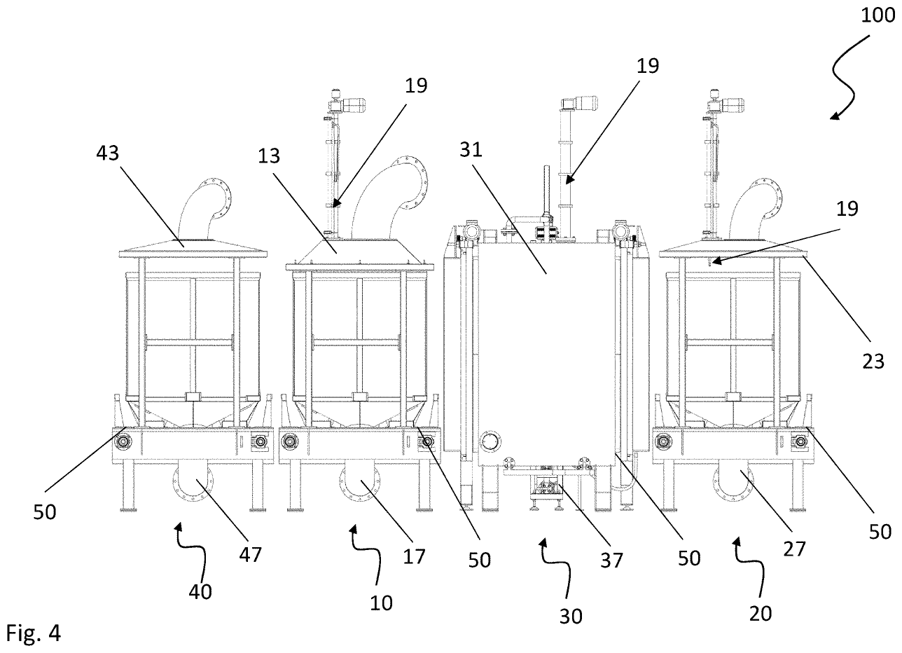

FIG. 1 show a schematic perspective view of a tray 11 of a roasting module 10 (see FIG. 4) according to an embodiment of the present invention. As illustrated the tray 11 is advantageously essentially cubic and has an opening 12 through which the products to be roasted, like beans, seeds, or nuts, can be inserted into the tray 11. The opening 12 can be covered by means of cover 13 as shown in FIG. 3. Cover 13 comprises advantageously an air outlet 14 for directing hot air and roasting by-products outside the tray 11. As shown in FIG. 4, the roasting module 10 (like the pre-heater module 20 and the cooling module 40), comprises means (not shown here) to lower and raise the cover 13 in order to close and open the opening 12.

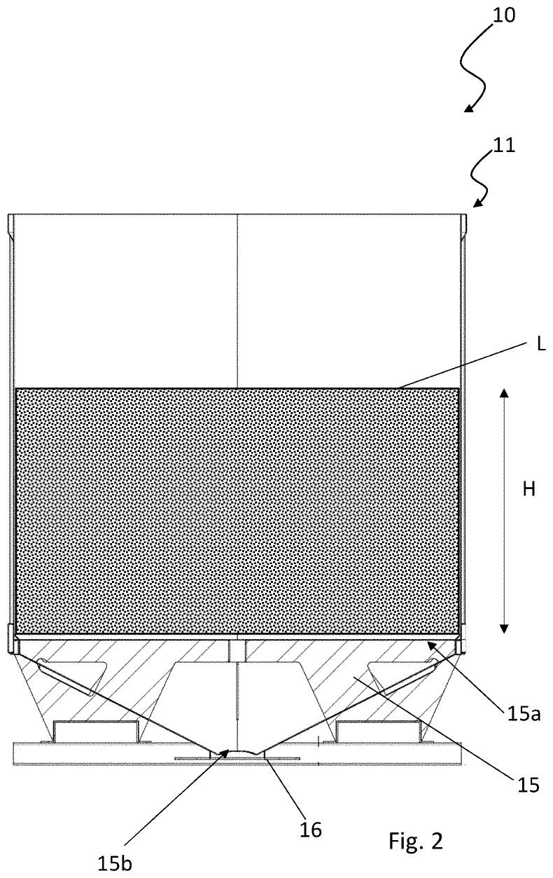

As shown in FIG. 2, tray 11 comprises a bottom in form of inverted truncated pyramid 15. The larger base 15a of the pyramid is covered by a grid with a mesh sufficiently small to retain the products to be roasted. The smaller base 15b is connected to an air inlet 16 (see FIG. 3) for supplying air into the tray 11. Inlet 16 is connected to a duct 17 of means for supplying hot air into the tray 11, in particular in the roasting module 10 air with a temperature between 115° C. and 200° C., advantageously between 125° C. and 170° C., in particular between 135° C. and 150° C. The inventors have found out that it is necessary to obtain homogenous roasting of the products in the tray 11, to supply hot air with a temperature in the above-mentioned temperature range and with a flow rate of at least 4′000 m³/hour per 1 m height H of products in the tray 11 (see FIG. 2, where L defined the level of products in the tray 11) and per 1 m² of surface of the larger base 15a of the inverted pyramid. The inlet 16 and the means for supplying hot air of the roasting module 10 are therefore configured to supply hot air with such a temperature and such a flow rate. With such a roasting module 10, it is thus possible to roast a large quantity of natural products, like beans, seeds, or nuts, without having to transport the product itself, thus avoiding damages to the product and the productions of dust.

Preferably the inlet 16 and/or the duct 17 have a seal, preferably an inflatable seal. That means that either the inlet 16 or the duct 17 have a seal, or both have each a seal.

Tray 11 comprises advantageously fork openings 18 for the insertion of the fork of a forklift. This allows for easily transporting the tray 11, for instance from a warehouse onto the belt 50 which allows for moving the tray 11 from one module of the processing line 100 (see FIG. 4) to another one.

As illustrated in FIG. 4, the roasting module 10, as well as the pasteurization module 30 and the pre-heater module 20, comprise advantageously sensor 19. The latter can be foreseen to measure the temperature and/or the humidity inside the tray 11.

FIG. 4 shows a side view of a processing line 100 according to one embodiment of the present invention. Processing line 100 comprises a pre-heater module 20, a roasting module 10, a pasteurization module 30 and a cooling module 40. Each of the pre-heater module, roasting module and cooling module have their dedicated cover 13, 23, 43 for covering a tray 11 when one is placed inside the corresponding module. The pre-heater module 20 comprises means 27 for inserting hot air with a temperature between 40° C. and 120° C., advantageously between 60° C. and 90° C., in particular between 70° C. and 80° C., into the tray 11 by means of the inlet 16. In a similar manner the cooling module 40 comprises means 47 for inserting air with a temperature between 15° C. and 35° C. into the tray 11 by means of the inlet 16. The pasteurization module 30 comprises a chamber 31 configured to create a sub-atmospheric pressure around tray 11, wherein means for inserting dry steam onto the products inside the tray 11 are provided in the chamber 31. Furthermore the pasteurization module 30 comprises means 37 for inserting air. Each module 10, 20, 30, and 40 comprises a belt 50 with motor 51 (see FIG. 3) which allows for moving the tray 11 from one module to another one.

Processing line 100 allows for a complete treatment of natural products, like beans, seeds, or nuts, from pre-heating, roasting, pasteurization and cooling to ambient temperature. Since all these steps are performed with the natural products kept inside the tray 11, it is possible to avoid damage of the product due to its transport like in prior art processing lines.

Finally, it should be pointed out that the foregoing has outlined one pertinent non-limiting embodiment. It will be clear to those skilled in the art that modifications to the disclosed non-limiting embodiment can be effected without departing from the spirit and scope thereof. As such, the described non-limiting embodiment ought to be considered merely illustrative of some of the more prominent features and applications. Other beneficial results can be realized by applying the non-limiting embodiments in a different manner or modifying them in ways known to those familiar with the art.

Furthermore each given preference may be combined with any other single or more preferences and such combinations may also be encompassed by the scope of the present invention.

1. A roasting module for roasting natural products, in particular beans, grains, seeds or nuts, comprising a tray, in particular a cubic tray, for containing the products to be roasted, wherein the tray comprises a bottom in the form of an inverted truncated pyramid, a grid covering the larger base of the inverted pyramid, wherein the mesh of the grid is sufficiently small to retain the products to be roasted when placed on the grid, the tray further comprising an opening positioned opposite the inverted pyramid, the opening being configured to introduce the products to be roasted into the tray, the tray further comprising on the smaller base of the inverted pyramid an air inlet, the roasting module comprising first means for supplying hot air into the tray through the inlet,
characterized in that
the inlet and the first means for supplying hot air are adapted to supply a flow of hot air with a rate of at least 4′000 m³/hour per 1 m of height of products to be roasted and per 1 m² of surface of the larger base of the inverted pyramid and in that the first means for supplying hot air are adapted to supply air at a temperature in the range of 105° C. to 250° C.

2. The roasting module according to claim 1, wherein the first means for supplying hot air are adapted to supply air at a temperature range between 115° C. and 200° C., advantageously between 125° C. and 170° C., in particular between 135° C. and 150° C., preferably for roasting of beans, seeds or nuts.

3. The roasting module according to claim 1, wherein it comprises a cover for covering the opening, wherein the cover comprises an outlet to direct hot air outside the tray.

4. The roasting module according to claim 1, wherein it comprises means for adjusting the temperature of the hot air to be supplied into the tray.

5. The roasting module according to claim 1, wherein it comprises a temperature sensor for measuring the temperature inside the tray.

6. The roasting module according to claim 1, wherein it comprises a humidity sensor for measuring the humidity level inside the tray.

7. The roasting module according to claim 5, wherein the means for adjusting the temperature of hot air is configured to receive data from the temperature sensor and/or the humidity sensor and to adjust the temperature of hot air to be supplied into the tray in function of the data received.

8. The roasting module according to claim 1, wherein the inlet is connected to an air filter, especially a HEPA filter.

9. The roasting module according to claim 1, wherein the inlet is connected to a duct of means for supplying hot air into the tray.

10. The roasting module according to claim 1, wherein the inlet and/or the duct comprise a seal, preferably an inflatable seal.

11. The roasting module according to claim 1, wherein the first means for supplying hot air into the tray comprises a delivery fan with variable speed to adjust the airflow depending on the density of the product in the tray.

12. The roasting module according to claim 1, comprising means for inverting the flow direction of the hot air.

13. A processing line for natural products, especially beans and nuts, wherein it comprises a pre-heater module for heating the natural products with hot air at a temperature of 40 to 120° C., advantageously of 60° C. to 90° C., in particular of 70° C. to 80° C., a cooling module for cooling the products to ambient temperature and between the pre-heater module and the cooling module a roasting module according to claim 1, wherein the processing line comprises means for displacing the tray for containing the products from the pre-heater module to the roasting module and from the roasting module to the cooling module.

14. The processing line according to claim 13, wherein it comprises between the pre-heater module and the roasting module, a pasteurization module for pasteurizing the products.

15. The processing line according to claim 13, wherein the pre-heater module comprises second means for supplying hot air into the tray, wherein the second means are configured to supply air with a temperature from 40° C. to 120° C., advantageously from 60° C. to 90° C. in particular from 70° C. to 80° C., through the inlet of the tray.

16. The processing line according to claim 13, wherein the cooling module comprises means for supplying cooled air into the tray, wherein the means for supplying cooled air are configured to supply air with a temperature from 15° C. to 35° C. through the inlet of the tray.

17. The processing line according to claim 13, wherein it comprises a controller for adjusting the temperature of the air supplied into the tray by the pre-heater module, the roasting module and the cooling module.

18. The processing line according to claim 17, wherein the controller is configured to control the means for displacing the tray between the modules.

19. The processing line according to claim 13, wherein each of the pre-heater module, the cooling module and the roasting module comprises a separated cover for covering the opening of the tray, wherein the covers exhibit an outlet for directing air outside the tray.

20. The processing line according to claim 13, wherein the tray comprises advantageously fork openings for the insertion of the fork of a forklift.

21. The processing line according to claim 13 comprising at least two roasting modules.

22. The processing line according to claim 13, whereby the inlet and/or the duct of each roasting module comprises seals, which preferably can be inflated once the tray is positioned thereon, to make the connection between the inlet and/or the duct of the one or more trays airtight.

23. Use of a roasting module according to claim 1 for roasting of natural products, in particular for roasting of beans, grains, seeds or nuts, more preferably for roasting of beans, seeds, tree nuts or ground nuts.

24. The use according to claim 23, wherein the beans are preferably soybeans, kidney beans, chickpeas, common peas, fava beans, lima beans, lupins, mung beans, pigeon beans and runner beans.

25. The use according to claim 23, wherein the grains and seeds are preferably sunflower seeds, sesame seeds, oat, malt, and pumpkin seeds.

26. The use according to claim 23, wherein the tree nuts are preferably almonds, hazelnuts, pecans, cashews, macadamias and pistachios, and/or the ground nuts are preferably peanuts.
